(19) United States
(12) Patent Application Publication
(10) Pub. No.: US 2017/0332682 A1
(43) Pub. Date: Nov. 23, 2017

(54) System and Method for Extracting Starch from Green Bananas

(71) Applicant: Himi Agricultural Biotech & Co., Taipei City (TW)

(72) Inventors: Chin Yuan Huang, Taipei City (TW); Jyh-Yih Leu, Taipei City (TW); Wen-Jen Yang, Taipei City (TW); Hao-Hsun Huang, Taipei City (TW)

(21) Appl. No.: 15/349,996

(22) Filed: Nov. 11, 2016

(30) Foreign Application Priority Data
May 18, 2016 (TW) 105207256

(51) Int. Cl. A23L 19/00; A23N 15/00; C08B 30/04

(52) U.S. Cl. CPC A23L 19/09; C08B 30/04; A23N 15/00; A23V 2002/00

(57) ABSTRACT

The present invention provides a system and method for extracting starch from green bananas. The system includes: a pretreatment module configured to grind and homogenize the green bananas so as to form green banana slurry; an extraction module configured to receive the green banana slurry, and configured to add an extraction solvent to the green banana slurry to generate an extracted mixture of green banana starch; a separation module, wherein the extracted mixture of green banana starch is held still in the separation module, so green banana starch precipitates and green banana suspensions are precipitated and separated; a first rinsing module configured to rinse green banana starch precipitates to remove any impurities except for the starch therein, thereby forming a banana starch cream; and, a dehydration module configured to remove water from the banana starch cream to form banana starch.

### CROSS-REFERENCE TO RELATED APPLICATION

This application claims the priority of Taiwanese patent application No. 105207256, filed on May 18, 2016, which is incorporated herewith by reference.

### BACKGROUND OF THE INVENTION

### 1. Field of the Invention

The present invention relates to a system for extracting starch from green bananas, more particularly, relates to a system that systematically separates banana starch from green bananas.

### 2. The Prior Art

Starch is known to be a main composition of rice and flour and is a type of polysaccharide that consists of amylose and amylopectin. After entering human bodies, starch will undergo the effect of different kinds of enzymes, such as salivary amylase, pancreatic amylase and maltase. Subsequently, starch will be broken down to glucose, which may be absorbed by intestinal mucosa. Once the amount of absorbed glucose exceeds the amount needed in a human body, most of the extra glucose will be converted into fat, which eventually leads to obesity. Hence, for those who are looking to lose weight, it is often suggested to control the intake of rice and noodles.

For those who want to lose weight but still wish to keep all the essential nutrients, it has always been a challenge to control the intake of rice and noodles to obtain the required daily nutrients or to fulfil his/her appetite while refraining from consuming too much glucose, which eventually are converted into fat.

Resistant starch is a type of starch that is more difficult to degrade than other types of starch. Not only the digestion process of resistant starch is slow, but the absorption process and the process of resistant starch entering blood vessels are also slow. The characteristics of resistant starch are similar to soluble fibers. Resistant starch and soluble fibers are both considered effective diet for weight losing and thus are favored by beauty lovers. Resistant starch is advantageous in many ways, for example, it has the same effects as soluble fibers and may be used to increase the defecation amount and also to ease constipation, thereby resulting in weight loss. Since resistant starch is resistant to digestion, the process of glucose release within human bodies is slow. Because of a low insulin reaction in human bodies, resistant starch may be used to keep blood sugar in balance, to reduce hunger and to control dietary intake. In addition, because the amount of cholesterol and triglyceride in the defecation will increase for those who consume resistant starch, resistant starch could also be used to reduce the cholesterol and triglyceride level.

On the other hand, researches have indicated that bananas are considered as “happy food”. Not only are bananas effective for weight loss, but they are also effective in relieving depression. Doctors have also pointed out that bananas comprise a large amount of resistant starch, which cannot be easily broken down by enzymes, and thus are able to provide a high satiety value and are able to fight off obesity. Among all types of bananas, green bananas have the highest amount of resistant starch. Green bananas are the best choice when it comes to using bananas as a weight loss diet. It is suggested to consume green bananas together with yogurt or green tea as meal replacements. It is even better to make banana juice from green bananas with peels attached for the purposes of refreshment, health benefits and prevention of obesity. Meanwhile, bananas are known to be rich in serum hormones that can increase metabolism and calm nerves. Serum hormones are also helpful for mood relaxation and depression relief. Hence, bananas are often referred to as a type of natural antidepressant fruit. Furthermore, the rich fibers in green bananas diet can increase bowel movement, thereby resulting in weight loss.

Based on the above reasons, there is an urgent need in the industry to develop a system and method capable of efficiently extracting resistant starch from green bananas in a mass volume.

### SUMMARY OF THE INVENTION

In view of the foregoing drawbacks, a primary objective of the present invention is to provide a system for extracting starch from green bananas, including: a pretreatment module, an extraction module, a separation module, a first rinsing module and a dehydration module. The pretreatment module is configured to grind and homogenize the green bananas so as to form green banana slurry. The extraction module is connected to the pretreatment module; in addition, the extraction module is configured to receive the green banana slurry, and is configured to add an extraction solvent to the green banana slurry to generate an extracted mixture of green banana starch. The separation module is connected to the extraction module. The extracted mixture of green banana starch is held still in the separation module, so green banana starch precipitates and green banana suspensions are precipitated and separated. The first rinsing module is connected to the separation module, and is configured to rinse green banana starch precipitates to remove any impurities except for the starch therein, thereby forming a banana starch cream. The dehydration module is connected to the first rinsing module, and is configured to remove water from the banana starch cream to form banana starch.

Preferably, the separation module further includes a separation acceleration unit. The separation acceleration unit is configured to stir or sieve the green banana suspensions so as to speed up the process that separates any unsettled green banana starch precipitates from the green banana suspensions.

Preferably, the separation acceleration unit is one of a stirring device, a first sieving machine, a vibrating sieve or any devices that are capable of performing a separation process based on molecular size.

Preferably, a peeling module is connected to the pretreatment module for peeling a plurality of peels of the green bananas in advance to pretreatment.

Preferably, the dehydration module includes a drying unit for drying the banana starch.

Preferably, the dehydration module is further connected to a milling unit for pulverizing the banana starch.

Preferably, the drying unit is one of a heated drying cabinet, a spray dryer or a freeze dryer.

Preferably, a second rinsing module is provided between the first rinsing module and the dehydration module for removing any impurities from the banana starch cream.

Preferably, the first rinsing module is one of a tank or a second sieving machine.

Preferably, the extraction solvent is one of an alkaline solvent or an acidic solvent.

On the other hand, the present invention also provides a method for extracting starch from green bananas, comprising the steps of: grinding and homogenizing the green bananas using a pretreatment module so as to form a green banana slurry; receiving the green banana slurry via an extraction module, and adding an extraction solvent to the green banana slurry to generate an extracted mixture of green banana starch; settling the extracted mixture of green banana starch using a separation module, so green banana starch precipitates and green banana suspensions are precipitated and separated; rinsing the green banana starch precipitates using a first rinsing module to remove any impurities except for the starch therein, thereby forming a banana starch cream; and, removing water from the banana starch cream using a dehydration module to form banana starch.

Preferably, the step of settling the extracted mixture of green banana starch using a separation module further includes a step of: stirring or sieving the green banana suspensions using a separation acceleration unit so as to speed up the process that separates any unsettled green banana starch precipitates from green banana suspensions.

Preferably, the separation acceleration unit is one of a stirring device, a first sieving machine, a vibrating sieve or any devices that are capable of performing a separation process based on molecular size.

Preferably, the method of the present invention further includes a step of: peeling a plurality of peels of the green bananas using a peeling module before the step of grinding and homogenizing the plurality of green bananas using the pretreatment module.

Preferably, the method of the present invention further includes a step of: drying the banana starch using a drying unit after the step of removing water from the banana starch cream using the dehydration module.

Preferably, the method of the present invention further includes a step of: pulverizing the banana starch using a milling unit after the step of drying the banana starch using the drying unit.

Preferably, the drying unit is one of a heated drying cabinet, a spray dryer or a freeze dryer.

Preferably, the method further includes a step of: removing any impurities from the banana starch cream using a second rinsing module after the step of rinsing the plurality of green banana starch precipitates using the first rinsing module.

Preferably, the extraction solvent is one of an alkaline solvent or an acidic solvent.

Preferably, a pH value of the alkaline solvent is larger than 11, and a pH value of the acidic solvent is smaller than 4.

Other purposes, advantages and innovative features of the present invention will become apparent by reading the following detailed description together with the accompanying drawings.

### BRIEF DESCRIPTION OF THE DRAWINGS

The present invention is best understood from the following detailed description when read in connection with the accompanying drawings. In order to achieve the foregoing objectives of the present invention, preferable embodiments of the present invention are illustrated in the drawings.

FIG. 1 is a block diagram illustrating a system for extracting starch from green bananas according to an embodiment of the present invention;

FIG. 2a is a schematic view illustrating a separation module according to an embodiment of the present invention;

FIG. 2b is a schematic view illustrating a separation module according to another embodiment of the present invention;

FIG. 2c is a schematic view illustrating a separation module according to yet another embodiment of the present invention;

FIG. 3a is a block diagram illustrating a dehydration module according to an embodiment of the present invention;

FIG. 3b is a block diagram illustrating a dehydration module according to another embodiment of the present invention;

FIG. 4 is a flow diagram illustrating a method for extracting starch from green bananas according to an embodiment of the present invention;

FIG. 5 is a flow diagram illustrating a method for extracting starch from green bananas according to other embodiments of the present invention;

FIG. 6 is a flow diagram illustrating a method for extracting starch from green bananas according to other embodiments of the present invention;

FIG. 7 is a flow diagram illustrating a method for extracting starch from green bananas according to other embodiments of the present invention; and

FIG. 8 is a flow diagram illustrating a method for extracting starch from green bananas according to other embodiments of the present invention.

### DETAILED DESCRIPTION OF THE PREFERRED EMBODIMENT

The present invention will be described in details with reference to the accompanying drawings in the following section. It should be noted that the drawings are not necessarily drawn to scale for the purpose of simplicity.

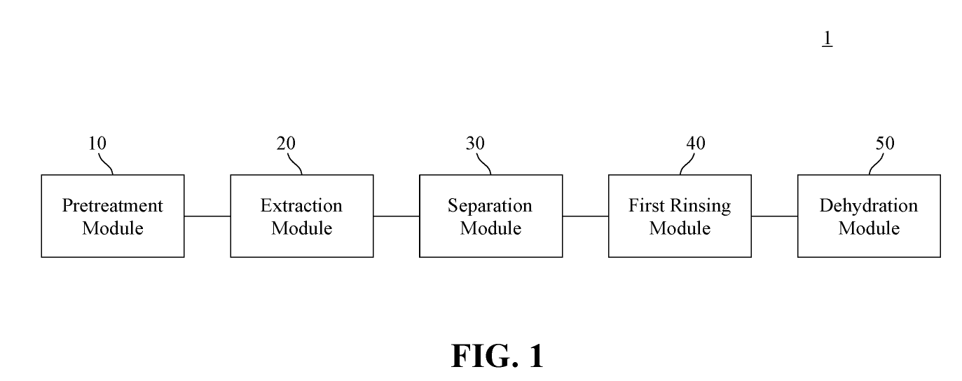

FIG. 1 is a block diagram illustrating a system for extracting starch from green bananas according to an embodiment of the present invention. As shown in FIG. 1, the system 1 for extracting starch from green bananas of the present invention includes: a pretreatment module 10, an extraction module 20, a separation module 30, a first rinsing module 40 and a dehydration module 50. The pretreatment module 10 is configured to grind and homogenize the green bananas so as to form the green banana slurry. The mesh size of the green banana slurry is smaller than 80. The green bananas may be put into the pretreatment module 10 for grinding and homogenizing in either peeled or unpeeled conditions. The extraction module 20 is connected to the pretreatment module 10. The extraction module 20 is configured to receive the green banana slurry, and is configured to add an extraction solvent to the green banana slurry to generate an extracted mixture of green banana starch. The extraction solvent may be one of an alkaline solvent or an acidic solvent, and is effective when used to soften cell walls for collecting the mixture of green banana starch. In an embodiment of the present invention, a pH value of the alkaline solvent is larger than 11, or even in a range of 11-12; on the other hand, a pH value of the acidic solvent is smaller than 4, or even in a range of 3-4. The separation module 30 is connected to the extraction module 20. The extracted mixture of green banana starch is held still in the separation module 30, so green banana starch precipitates and green banana suspensions are precipitated and separated. The first rinsing module 40 is connected to the separation module, and is configured to rinse green banana starch precipitates to remove any impurities except for the starch therein, thereby forming a banana starch cream. The dehydration module 50 is connected to the first rinsing module 40, and is configured to remove water from the banana starch cream to form the banana starch. The degree of purity of the banana starch extracted by the system 1 of the present invention may be higher than 90%.

In addition, in another embodiment of the present invention, the pretreatment module 10 may be further connected to a peeling module (not shown). The peeling module is connected to the pretreatment module 10 for peeling the peels of the green bananas in advance to pretreatment. The pretreatment module 10 may be a blender machine. Meanwhile, in a further embodiment of the present invention, the extraction module 20 and the separation module 30 may be combined together as an extraction-separation module for the simplicity of operation.

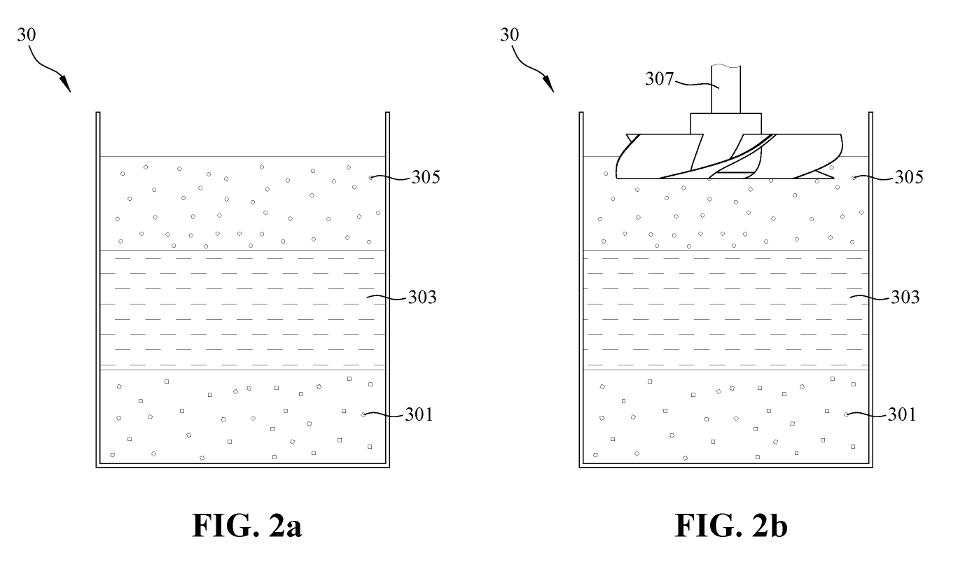

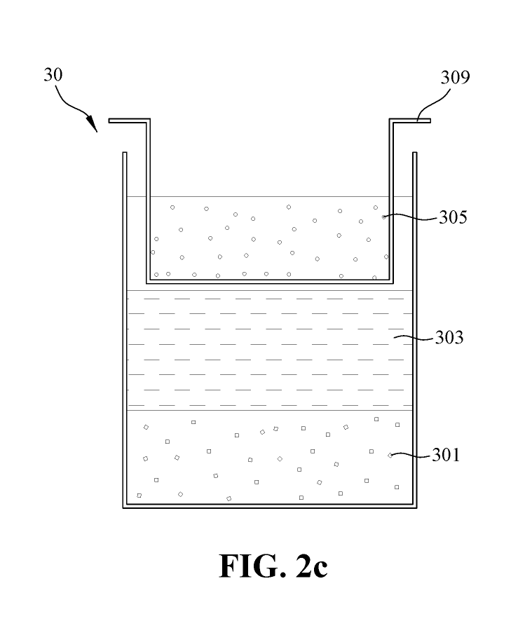

FIGS. 2a, 2b and 2c are schematic views illustrating different embodiments of the separation module. The detailed operation of the separation module 30 will be described below in reference to FIG. 1 and FIG. 2a. The extracted mixture of green banana starch is held still in the separation module 30, so green banana starch precipitates 301 and green banana suspensions 305 are precipitated and separated from the mixture of green banana starch. During the separation process, undesired impure wastewater 303 is also generated. In an embodiment of the present invention, the first rinsing module 40 may be used to rinse the green banana starch precipitates 301 directly to remove any impurities except for the starch therein, thereby forming a banana starch cream. In other embodiments of the present invention, the separation module 30 may further include a separation acceleration unit. The separation acceleration unit is configured to stir or sieve the green banana suspensions 305 so as to speed up the process that separates any unsettled green banana starch precipitates 301 from the green banana suspensions 305. As shown in FIGS. 2b and 2c, the separation acceleration unit may be one of a stirring device 307, a first sieving machine 309, a vibrating sieve or any devices that are capable of performing a separation process based on molecular size. The stirring device 307 is able to continuously stir the green banana suspensions 305. The first sieving machine 309 is able to continuously vibrate and sieve the green banana suspensions 305. Any unsettled green banana starch precipitates 301 in the green banana suspensions 305 will be separated during the process of stirring or sieving. Herein, the mesh size of the first sieving machine 309 is in the range of 60-150.

On the other hand, in an embodiment of the present invention, the first rinsing module 40 may be one of a tank or a second sieving machine. When the first rinsing module 40 is a tank, the operator may manually wash the green banana starch precipitates 301 repeatedly to remove any impurities included therein to form the banana starch cream. When the first rinsing module 40 is the second sieving machine, the operator may remove any impurities included in the green banana starch precipitates 301 with the vibration of the second sieving machine so as to form the banana starch cream. Herein, the mesh size of the second sieving machine is between the sizes of 150-280.

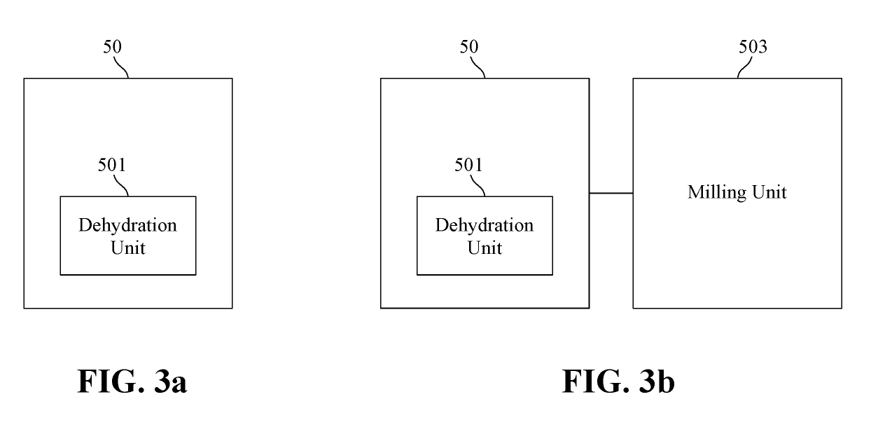

FIGS. 3a and 3b are block diagrams showing different embodiments of the dehydration module of the present invention. As shown in FIG. 3a, in one embodiment of the present invention, the dehydration module 50 may include a drying unit 501. After the water in the banana starch cream is removed by the dehydration module 50 and the banana starch is formed, the drying unit 501 further dries the banana starch. Normally, the drying temperature of the drying unit 501 should not exceed 70 degree Celsius. In most situations, the drying temperature of the drying unit 501 is set in the range of 60-70 degrees so as to avoid gelatinization. However, the drying temperature of the drying unit 501 may exceed 70 degree Celsius in some rare circumstances. As shown in FIG. 3b, in another embodiment of the present invention, the dehydration module 50 may be further connected to a milling unit 503 in addition to the drying unit 501. After the banana starch is dried by the drying unit 501, the milling unit 503 further mills the banana starch so as to pulverize the banana starch. Furthermore, in one embodiment of the present invention, the drying unit 501 may be one of a heated drying cabinet, a spray dryer or a freeze dryer.

In yet another embodiment of the present invention, a second rinsing module (not shown) is provided between the first rinsing module and the dehydration module. The second rinsing module is configured to further remove any impurities from the banana starch cream so as to increase the degree of purity. Herein, the second rinsing module may be a third sieving machine. The mesh size of the third sieving machine is between the sizes of 280-500.

On the other hand, in one embodiment of the present invention, the first sieving machine 309, the second sieving machine and the third sieving machine may be a vibrating sieve, respectively. When vibrating, the vibrating sieve has a main vibrating frequency and/or a sub-vibrating frequency. When the vibrating sieve is vibrating at the main vibrating frequency, an inertia force is generated to separate impurities from the green banana starch precipitates 301 and/or to separate impurities from starch. Modulating a sub-vibrating frequency (also referred to as sub-sound frequency) with a higher frequency within the main vibrating frequency has a similar effect to ultrasonic cleaning. The frequency of the sub-sound frequency is modulated so that the Van der Waals bonds between starch and impurities are in resonance. As a result, starch is separated from impurities. Subsequently, the inertia force generated by the main vibrating frequency may further separate starch from impurities. The frequency range of the sub-sound frequency is determined by the Van der Waals force between the substances to be separated. The range of the main vibrating frequency is determined by the masses of the substances to be separated.

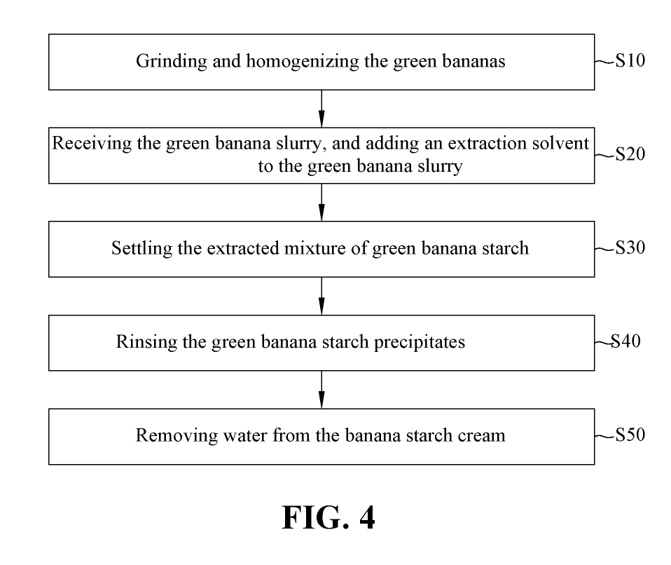

Furthermore, the present invention also provides a method for extracting starch from green bananas. FIG. 4 is a flow diagram illustrating the method for extracting starch from green bananas according to an embodiment of the present invention. As shown in FIG. 4, the method for extracting starch from green bananas according to an embodiment of the present invention includes the following steps S10-S50: step S10: grinding and homogenizing the green bananas using a pretreatment module so as to form the green banana slurry; step S20: receiving the green banana slurry via an extraction module, and adding an extraction solvent to the green banana slurry to generate an extracted mixture of green banana starch; step S30: settling the extracted mixture of green banana starch using a separation module, so green banana starch precipitates and green banana suspensions are precipitated and separated; step S40: rinsing the green banana starch precipitates using a first rinsing module to remove any impurities except for the starch therein, thereby forming a banana starch cream; and, step S50: removing water from the banana starch cream using a dehydration module to form banana starch.

The step S20 of the method according to an embodiment of the present invention, the extraction solvent may be one of an alkaline solvent or an acidic solvent, and is effective when used to soften cell walls for collecting the mixture of green banana starch. In an embodiment of the present invention, a pH value of the alkaline solvent is larger than 11, or even in a range of 11-12; on the other hand, a pH value of the acidic solvent is smaller than 4, or even in a range of 3-4.

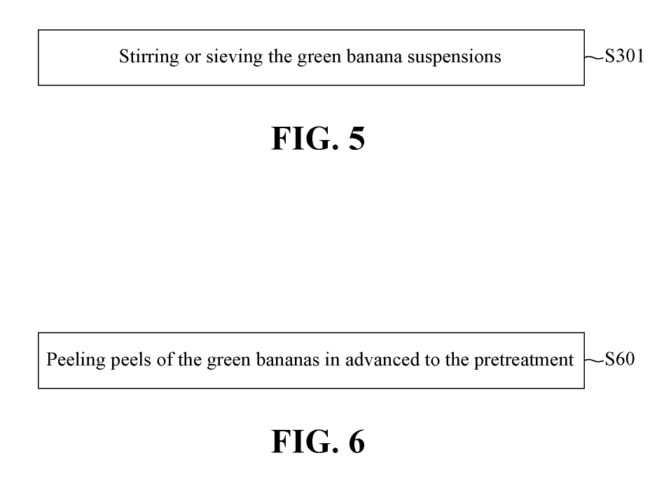

On the other hand, FIG. 5 is a flow diagram illustrating the method for extracting starch from green bananas according to other embodiments of the present invention. As shown in FIG. 5, in other embodiments of the present invention, step S30 may further includes a step S301: stirring or sieving the green banana suspensions using a separation acceleration unit so as to speed up the process that separates any unsettled green banana starch precipitates from green banana suspensions. Herein, the separation acceleration unit is one of a stirring device, a first sieving machine, a vibrating sieve or any devices that are capable of performing a separation process based on molecular size. The stirring device is able to continuously stir the green banana suspensions. The first sieving machine is able to continuously vibrate and sieve the green banana suspensions. Any unsettled green banana starch precipitates in the green banana suspensions will be separated during the process of stirring or sieving. Herein, the mesh size of the first sieving machine is in the range of 60-150. In step S40, when the first rinsing module is a second sieving machine, the operator may remove any impurities included in the green banana starch precipitates with the vibration of the second sieving machine so as to form the banana starch cream. Herein, the mesh size of the second sieving machine is between the sizes of 150-280.

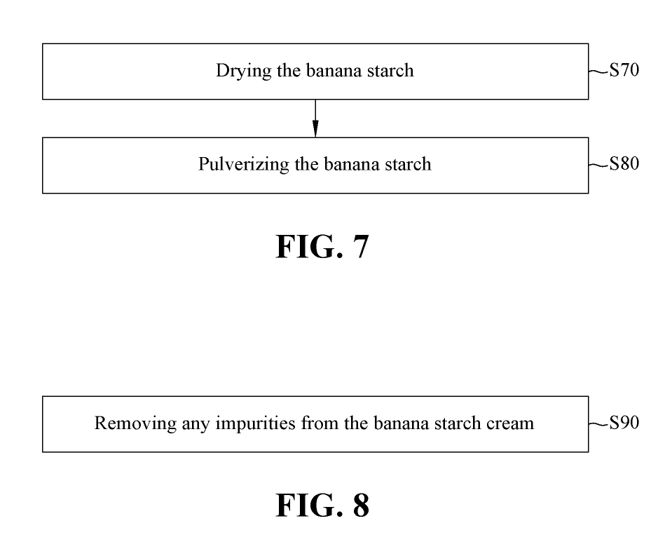

Furthermore, FIG. 6 is a flow diagram illustrating the method for extracting starch from green bananas according to other embodiments of the present invention. As shown in FIG. 6, in other embodiments of the present invention, a step S60 is performed before the step S10. Step S60 includes: peeling peels of the green bananas using a peeling module in advanced to the pretreatment. Moreover, FIG. 7 is a flow diagram illustrating the method for extracting starch from green bananas according to other embodiments of the present invention. As shown in FIG. 7, in other embodiments of the present invention, a step S70 and a step S80 may be included after the step S50. The step S70 includes: drying the banana starch using a drying unit. The step S80 includes: pulverizing the banana starch using a milling unit. Herein, the drying unit may be one of a heated drying cabinet, a spray dryer or a freeze dryer.

In addition, FIG. 8 is a flow diagram illustration the method for extracting starch from green bananas according to other embodiments of the present invention. As shown in FIG. 8, according to other embodiments of the present invention, a step S90 may be provided between the step S40 and the step S50. The step S90 includes: removing any impurities from the banana starch cream using a second rinsing module. In such a way, the degree of purity of the banana starch may be increased. Herein, the second rinsing module may be a third sieving machine. The mesh size of the third sieving machine is between the sizes of 280-500.

Similarly, in the method for extracting starch from green bananas provided by the present invention, the first sieving machine, the second sieving machine and the third sieving machine may be a vibrating sieve, respectively. When vibrating, the vibrating sieve has a main vibrating frequency and/or a sub-vibrating frequency. When the vibrating sieve is vibrating at the main vibrating frequency, an inertia force is generated to separate impurities from the green banana starch precipitates 301 and/or to separate impurities from starch. Modulating a sub-vibrating frequency (also referred to as sub-sound frequency) with a higher frequency within the main vibrating frequency has a similar effect to ultrasonic cleaning. The frequency of the sub-sound frequency is modulated so that the Van der Waals bonds between starch and impurities are in resonance. As a result, starch is separated from impurities. Subsequently, the inertia force generated by the main vibrating frequency may further separate starch from impurities. The frequency range of the sub-sound frequency is determined by the Van der Waals force between the substances to be separated. The range of the main vibrating frequency is determined by the masses of the substances to be separated.

It can be known from the above embodiments that the system and method provided by the present invention are able to systematically extract starch from green bananas. The system provided by the present invention is able to extract starch from a mass volume of green bananas at the same time, thereby saving a lot of time. In addition, by using the separation module to remove impurities from the extracted mixture of green banana starch, and by further rinsing the green banana starch precipitates with at least one rinsing module, the degree of purity of the final green banana starch could be higher than 90%.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A system for extracting starch from green bananas, comprising:
a pretreatment module configured to grind and homogenize the plurality of green bananas so as to form a green banana slurry;
an extraction module connected to the pretreatment module, wherein the extraction module is configured to receive the green banana slurry, and is configured to add an extraction solvent to the green banana slurry to generate an extracted mixture of green banana starch;
a separation module connected to the extraction module, wherein the extracted mixture of green banana starch is held still in the separation module, so a plurality of green banana starch precipitates and a plurality of green banana suspensions are precipitated and separated;
a first rinsing module connected to the separation module, wherein the first rinsing module is configured to rinse the plurality of green banana starch precipitates to remove any impurities except for the starch therein, thereby forming a banana starch cream; and
a dehydration module connected to the first rinsing module, wherein the dehydration module is configured to remove water from the banana starch cream to form a banana starch.

2. The system according to claim 1, wherein the separation module further comprises a separation acceleration unit, the separation acceleration unit is configured to stir or sieve the plurality of green banana suspensions so as to speed up the process that separates any unsettled green banana starch precipitates from the plurality of green banana suspensions.

3. The system according to claim 2, wherein the separation acceleration unit is one of a stirring device, a first sieving machine, a vibrating sieve or any devices that are capable of performing a separation process based on molecular size.

4. The system according to claim 1, wherein a peeling module is connected to the pretreatment module for peeling a plurality of peels of the green bananas in advance to pretreatment.

5. The system according to claim 1, wherein the dehydration module includes a drying unit for drying the banana starch.

6. The system according to claim 5, wherein the dehydration module is further connected to a milling unit for pulverizing the banana starch.

7. The system according to claim 5, wherein the drying unit is one of the following:
a heated drying cabinet, a spray dryer or a freeze dryer.

8. The system according to claim 1, wherein a second rinsing module is provided between the first rinsing module and the dehydration module for removing any impurities from the banana starch cream.

9. The system according to claim 1, wherein the first rinsing module is one of a tank or a second sieving machine.

10. The system according to claim 1, wherein the extraction solvent is one of an alkaline solvent or an acidic solvent.

11. A method for extracting starch from green bananas, comprising:
grinding and homogenizing the plurality of green bananas using a pretreatment module so as to form a green banana slurry;
receiving the green banana slurry via an extraction module, and adding an extraction solvent to the green banana slurry to generate an extracted mixture of green banana starch;
settling the extracted mixture of green banana starch using a separation module, so a plurality of green banana starch precipitates and a plurality of green banana suspensions are precipitated and separated;
rinsing the plurality of green banana starch precipitates using a first rinsing module to remove any impurities except for the starch therein, thereby forming a banana starch cream; and
removing water from the banana starch cream using a dehydration module to form a banana starch.

12. The method according to claim 11, wherein the step of settling the extracted mixture of green banana starch using a separation module further comprises a step of: stirring or sieving the plurality of green banana suspensions using a separation acceleration unit so as to speed up the process that separates any unsettled green banana starch precipitates from the plurality of green banana suspensions.

13. The method according to claim 12, wherein the separation acceleration unit is one of a stirring device, a first sieving machine, a vibrating sieve or any devices that are capable of performing a separation process based on molecular size.

14. The method according to claim 11 further comprising a step of: peeling a plurality of peels of the green bananas using a peeling module before the step of grinding and homogenizing the plurality of green bananas using the pretreatment module.

15. The method according to claim 11 further comprising a step of: drying the banana starch using a drying unit after the step of removing water from the banana starch cream using the dehydration module.

16. The method according to claim 15 further comprising a step of: pulverizing the banana starch using a milling unit after the step of drying the banana starch using the drying unit.

17. The method according to claim 15, wherein the drying unit is one of the following: a heated drying cabinet, a spray dryer or a freeze dryer.

18. The method according to claim 11 further comprising a step of: removing any impurities from the banana starch cream using a second rinsing module after the step of rinsing the plurality of green banana starch precipitates using the first rinsing module.

19. The method according to claim 11, wherein the extraction solvent is one of an alkaline solvent or an acidic solvent.

20. The method according to claim 19, wherein a pH value of the alkaline solvent is larger than 11, and a pH value of the acidic solvent is smaller than 4.
